(19) United States
(12) Patent Application Publication
(10) Pub. No.: US 2003/0110243 A1
(43) Pub. Date: Jun. 12, 2003

(54) Method, system and policy decision point (PDP) for policy-based test management

(75) Inventor: Said Soulhi, Saint-Laurent (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(73) Assignee: Telefonaktiebolaget L M Ericsson (publ)

(21) Appl. No.: 10/004,845

(22) Filed: Dec. 7, 2001

(51) Int. Cl. G06F 15/173

(52) U.S. Cl. 709/223

(57) ABSTRACT

A method, system and Policy Decision Point (PDP) for policy-based test management wherein high-level test goals are first defined, and high-level test policies are next created based upon the test goals. The test policies are then converted into vendor and technology specific test scripts which are transmitted, along with the test policies, from a test management tool, to a PDP such as for example to a test server, to an Element Manager/Network Manager (EM/NM), or to a Network Element (NE), where they are stored. Upon detection of a given condition, the PDP-stored test policies trigger execution of one or more associated test scripts for testing a given network entity of a monitored network, and the test results are reported back to the test management tool.

### BACKGROUND OF THE INVENTION

1. Field of the Invention

The present invention relates to network management, and particularly to test management for systems and networks.

2. Description of the Related Art

Computer-based networks are well known nowadays. They are used in different areas of the industry, ranging from Local Area Networks (LANs), through cellular telecommunications networks, to satellite networks, etc. It is well known in the art that for maintaining such networks in a performant state so that they can provide the expected services, some level of network and test management is required. For example, in cellular telecommunications networks, there are two recommendations to support generic test management. The Open Systems Interconnection (OSI)—Systems Management: Test Management Function, ITU—T Recommendation X.745, published by the International Telecommunications Union (ITU), herein included by reference, models resources for testing management. The OSI—Systems Management: Confidence and Diagnostic Test Categories, ITU-T X.737/ISO 10164-14, published by the ITU and herein included by reference, specifies an information model for a set of generic basic tests, such as communication path loops, which may be invoked by the services specified in the previously identified Recommendation X.745.

However, the OSI approach for test management comprises a significant drawback in that it is device centric, must be defined using low-level programming code, and cannot be based on high-level test management needs. Therefore, the OSI approach has no level of abstraction, it is not scalable, and consequently, its lack of scalability renders it difficult to adapt to a wide range of test management needs.

Reference is now made to FIG. 1 (Prior Art), which shows a high-level network diagram of a typical Prior Art implementation of test management according to the OSI approach based on the manager-agent relationship. In particular, FIG. 1 shows a test management system 100 comprising a test manager 102 responsible for interaction with a testing agent 104, which encapsulates a well-defined subset of test functions. The test management system 100 is further connected to a plurality of managed network elements 105, including a managed network element 106, of a managed network 108. For example, the managed network 108 may be a cellular telecommunications network and the managed network element 106 may be a base station providing radio support for a plurality of mobile phones (not shown). Periodically, a network operator of the monitor network 108 may desire to perform specific tests in order to insure that the various elements of the network are functioning properly. For this purpose, the operator instructs a test conductor 110 of the test manager 102 to launch a given test on a given network element of the network 108, such as for example on the network element 106. Hence, a test request 112 is sent from the manager 102 to the agent 104, and upon receipt of the test request 112, a test performer 114 of the agent 104 executes a given code associated with the selected test request 112, action 116. Once the test is executed by the network element 106, the test results 118 are reported back through the agent 104 to the operator of the manager 102, which may allow for some corrective action to be taken, if justified by the test results 118.

Accordingly, it can be seen from the above description that the OSI approach involves human intervention in the performance of the tests and is therefore prone to human errors. Furthermore, when defining the test code in the test performer 114, the test administrator must know vendor and technology specific details related to the test and to the tested network element, which further complicates and lengthens the test process.

Although there is no prior art solution as the one proposed hereinafter for solving the above-mentioned deficiencies, the International Application WO 00/7514, published on Nov. 30, 2000 to Tse et al (hereinafter called Tse) bears some relation with the field of the present invention. Tse teaches a system and method for monitoring alarm information in a fault management system of a network and for minimizing the amount of alarm information displayed in a graphical display system. An alarm message indicating an alarm condition for a specific element in that network is received by a graphical display system. Information about the specific element is extracted from the alarm message and a graphical object for the specific element is created based on the extracted information. The graphical object is then displayed on a network operator interface, and when the alarm condition is cleared, the graphical object is removed from the graphical display system. However, Tse's teaching is limited to the receipt of an alarm message by the graphical display system, and fails to disclose any manner in which system testing is performed.

The U.S. Pat. No. 6,154,849 published on Nov. 28, 2000 to Xia (hereinafter called Xia) teaches a method and apparatus that allows flexibility in the case of a failure diagnosis, so that a single failure event received by a failure analysis system can affect the availability of different resources in different ways, by allowing the dependency between resources to be relaxed in certain circumstances. Each failure event in the failure diagnosis system is processed in accordance with dependency logic that describes the strength of the dependency between various system resources and further determines the precedings if there are multiple dependencies between resources. The dependency logic further determines whether a resource depended on by the current resource is internal or external. In addition, the dependency logic includes relaxation rules, which define how a dependency on a particular resource is to be relaxed for a particular current resource. Xia teaches a recovery technique to be used following a failure event, which is based on resource dependency relaxation. Therefore, Xia fails to disclose or suggest testing techniques for identifying the failure as the ones proposed by the Applicant.

The Internet Engineering Task Force (IETF) policy framework group and the IETF IPSec policy group define how to apply policy based management techniques to Quality of Service (QoS) management and to Security Management. However, the policy-based test management field is not covered at all in the IETF, nor in any other standard body.

Accordingly, it should be readily appreciated that in order to overcome the deficiencies and shortcomings of the existing solutions, it would be advantageous to have a method and system for allowing easy definition and execution of networks and elements testing. It would be even more advantageous to have a method and system that allows simple definition of high-level, vendor, protocol and technology independent test policies to be applied for particular test management. The present invention provides such a solution.

### SUMMARY OF THE INVENTION

It is one broad object of the present invention to provide self-testable telecommunications and data networks driven by high-level testing objectives and policies.

The present invention is a method, system and Policy Decision Point (PDP) for policy-based test management wherein high-level test goals are first defined, and high-level test policies are next created based upon the test goals. The test policies are then converted into vendor and technology specific test scripts which are transmitted, along with the test policies, from a test management tool, to a PDP such as for example to a test server, to an Element Manager/Network Manager (EM/NM), or to a Network Element (NE), where they are stored. Upon detection of a given condition, the PDP-stored test policies trigger execution of one or more associated test scripts for testing a given network entity of a monitored network, and the test results are reported back to the test management tool.

Accordingly, the invention provides a method for policy-based test management, the method comprising the steps of:

i) defining at least one high-level test policy for test management, the test policy comprising one or more testing actions to be executed when one or more pre-defined conditions are met;

ii) based on the high-level test policy, creating one or more test scripts associated to the testing actions of the test policy, the test scripts being set to be executed when the one or more pre-defined conditions are met;

iii) detecting when the one or more pre-defined conditions are met; and

iv) executing the one or more test scripts.

The invention further provides a policy-based test management system comprising:

a test management functionality defining at least one high-level test policy for test management comprising one or more testing actions to be executed when one or more pre-defined conditions are met, wherein the test management functionality is used to create one or more test scripts associated to the testing actions and based on the high-level test policy, the test scripts being set to be executed when the one or more pre-defined conditions are met; and

a Policy Decision Point (PDP) connected to the test management functionality and detecting when the one or more pre-defined conditions are met.

It is yet another object of the invention to provide a Policy Decision Point (PDP) comprising:

a Policy Information Base (PIB) storing:

i) at least one high-level test policy for test management, the test policy comprising one or more testing actions to be executed when one or more pre-defined conditions are met;

ii) one or more test scripts associated with the testing actions of the test policy, the test scripts being set to be executed when the one or more pre-defined conditions are met;

an engine detecting when the one or more pre-defined conditions are met, and if so, triggering an execution of the test scripts.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level network diagram illustrative of a typical Prior Art implementation for testing management;

FIG. 2.a is a high-level flowchart diagram illustrative of the preferred embodiment of the present invention related to policy based test management;

FIG. 2.b is another high-level flowchart diagram illustrative of the preferred embodiment of the present invention related to policy based test management;

FIG. 3 is an exemplary high-level network diagram of a first variant of the preferred embodiment of the present invention;

FIG. 4 is an exemplary high-level network diagram of a second variant of the preferred embodiment of the present invention; and

FIG. 5 is an exemplary high-level network diagram of a third variant of the preferred embodiment of the present invention.

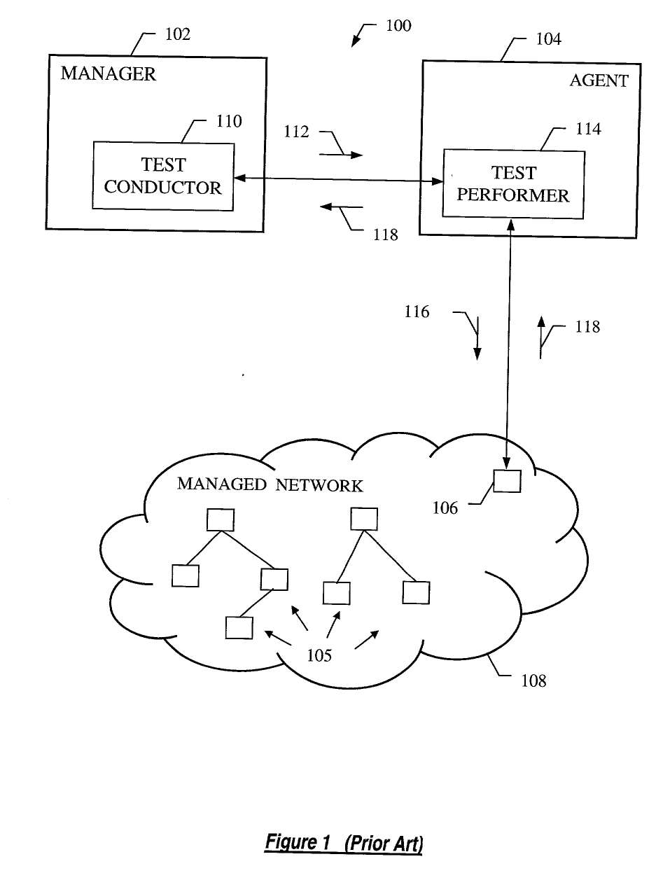

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

The present invention provides a method and system for allowing networks and network elements to be tested based on predefined high-level test policies. As the task of managing network resources becomes increasingly complex, in order to prevent administrators from drowning in excessive details, the present invention allows managing a network at a level of abstraction that hides system and vendor specific details. According to the invention, test policies are administratively defined with a high-level of abstraction and stored in a policy repository. A test management tool may function to retrieve the set of test policies and convert it into lower level test scripts. Test policies along with the test scripts are then distributed to a Policy Decision Point (PDP), such as for example to a test server, an Element Manager/Network Manager (EM/NM), or to a Network Element (NE) for detecting when particular conditions occur for triggering execution of the test scripts. In this manner, PDPs are pre-configured based on the pre-established high-level policies, prior to processing events. When particular conditions are met, such as for example a receipt of a given type of alarm notification, the pre-determined conditions are detected by the high-level test policies and the test scripts are sent to the appropriate Police Enforcement Points (PEPs), i.e. to the appropriate network element(s) of the managed network, and executed. Test results are also reported back to the appropriate network management entity.

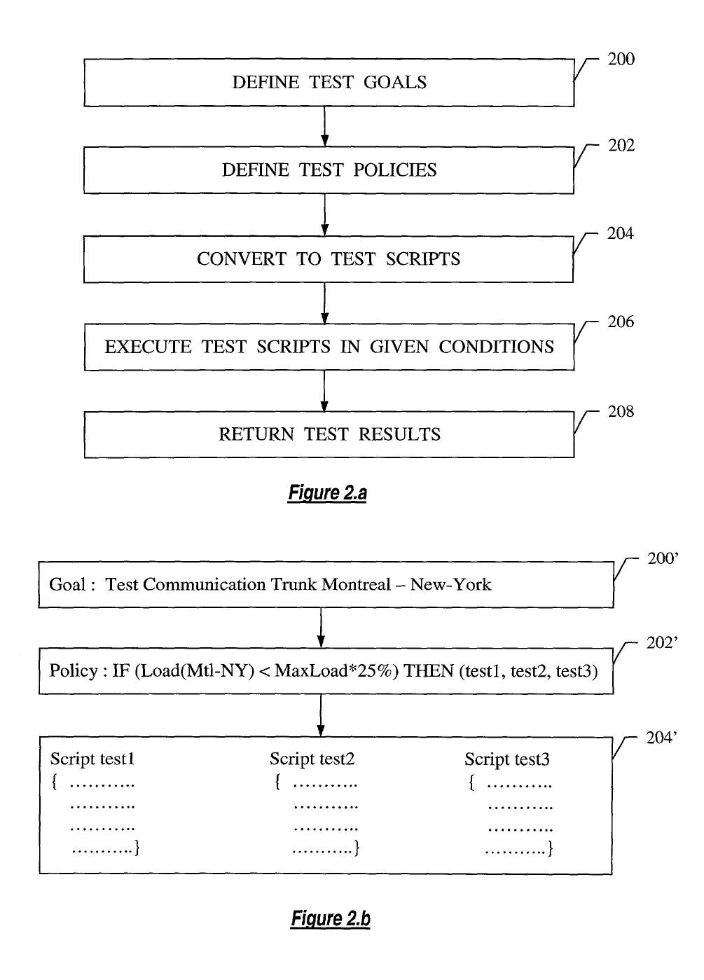

Referring now to FIG. 2.a, depicted therein is a functional flowchart diagram illustrating the broad aspect of the present invention. In step 200, high-level test goals are defined, such as for example in large terms or in terms of expected test results. The test goals can also be defined as one or more generic rules. In step 202, high-level test policies are defined based on the test goals. The test policies may comprise a set of policies, or rules, in the form “IF (Condition) THEN (Action)”, or any equivalent alternate expression, wherein an action is a set of one or more tests to be taken when a given condition (e.g. a network element status) is detected. The test goals, as well as the test policies, defined in actions 200 and 202 respectively, are expressions that are technology, protocol, and vendor independent. In action 204, the high-level test policies are converted into one or more technology and vendor specific test scripts that will perform the actual tests on pre-determined network element(s). When a given condition is met, the corresponding set of test scripts is executed, action 206, and the test results are returned for evaluation, action 208.

Reference is now made to FIG. 2.b, which shows an example of test goals, test policies and test scripts that can be used according to the preferred embodiment of the present invention. In step 200′ the test goals are defined, such as for example to “test a telecommunication trunk connecting the cities of Montreal and New York”. In step 202′, test policies are deducted from the high-level test goals, such as for example performing “test1, test2, and test3 ” when the “load on the telecommunication trunk connecting the cities of Montreal and New York is less then 25% of the maximum load”. In step 204′, the test policies are converted into actual test scripts corresponding to the three tests test1, test2 and test3, which will be executed on the actual components of the Montreal-New-York telecommunications trunk. Another example could be “test all radio base stations in a region when the number of dropped calls exceeds a specific threshold”

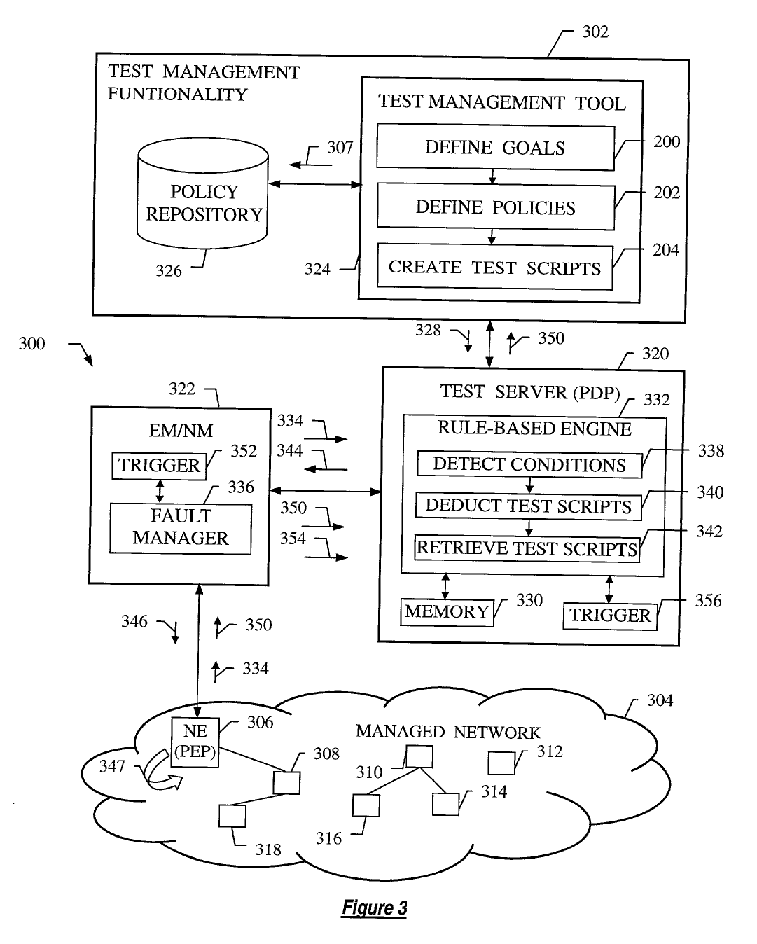

FIG. 3 is an exemplary high-level network diagram of a first variant of the preferred embodiment of the present invention. A test management system 300 comprises a test management functionality 302 responsible for the definition of test goals, test policies and test scripts that are to be used for the management of a managed network 304 comprising one or more managed network elements 306-318. A test server 320 (to be described) is used for interfacing the test management functionality 302 with an Element Manager/Network Manager (EM/NM) 322 which comprises element management functions and subnetwork management functions as defined, for example, in the Technical Specification TS32.101 by the Third Generation Partnership Project (3GPP), herein included by reference, for the purpose of managing a network by having direct access to the managed networks' elements. The test server 320 acts as a Policy Decision Point (PDP) to detect particular conditions, derive test decisions and distributes them, along with the appropriate test scripts, to the appropriate network element, which acts as a Policy Enforcement Point (PEP) by executing the test scripts in a manner to be described.

First, a test management tool 324 may be used in the test management functionality 302 for defining the high-level test goals, action 200, the high-level test policies in accordance with the high-level test goals, action 202, and for creating the corresponding test scripts based on the previously defined test policies, action 204. The test policies created in action 204 may also be temporarily stored on a policy repository 326 of the test management functionality 302, action 307, pending conversion into test scripts. Once the test policies and the test scripts are defined and created, they are sent in action 328 to test server 320, where they may be stored in a memory 330. As described, the test rules may comprise an expression of the form “IF(Condition) THEN (Action)”, wherein the “Action” is linked to an execution of one or more test scripts on one or more network elements of the managed network, when the “Condition” is met. A processor or an application of the test server 320, herein called a rule-based engine 332, may continuously monitor for detecting a condition similar to the one(s) set into the test policies provisioned to test server 320, which would trigger execution of the test scripts. For example, following the provision 328 of the test rules and the test scripts to the test server 320, the monitored network element 306 may issue and transmit an alarm 334 to a fault manager 336 of the EM/NM 322, which in turn relays the alarm notification 334 to the test server 320. The rule-based engine 332 detects if the received alarm notification 334 equals one of the conditions set into the test policies, action 338, and if so, deducts the corresponding test scripts to be executed for such a condition, step 340. Once the required test scripts are identified, the rule-based engine 332 retrieves the corresponding test scripts from the memory 330, action 342 and transmits the test scripts to the fault manager 336 of the EM/NM 322, action 344, which in turn forwards the test scripts to the network element 306, action 346. The tests scripts are received by the network element 306 and executed, action 347. Finally, test results are reported back to the test management tool 302, or to any other administrative entity as predefined by a network administrator, action 350.

According to the first variant of the preferred embodiment of the present invention, besides an alarm notification, other various events or conditions may trigger the execution of the test scripts, as described. First, for example, the EM/NM 322 may further comprise a trigger T 352 that may detect a pre-defined situation, such as for example but not limited to a pre-defined time value, or a processing load value associated with the monitored network element 306, etc. In such a case, the trigger 352 sends a trigger value 354 to the test server 320, which the former uses for allowing the rule based engine to detect if the test policies condition is met for triggering any of the test scripts stored in memory 330, as described. Second, the test server 320 may itself comprise a trigger 356 that may directly input into the rule based engine 332 a trigger value such as for example but not limited to a pre-defined time value, a processing load value associated with the monitored network element 306, etc. In such a case, the trigger 356 sends a trigger value (not shown) to the rule based engine 332, which the former uses to detect if the test policies condition is met for triggering any of the test scripts stored in memory 330, as described.

It is to be noted that in the example described in relation to FIG. 3, also called herein an outsourcing model, the test decisions are outsourced to an external entity, i.e. to the Test Server. The protocol used for communications between the test server 320 and the EM/NM 322 is the COPS (Common Open Policy Service) protocol, which is a simple request/response protocol between PEPs and PDPs to exchange policy information and decisions. The COPS protocol was published in January 2000 by the Internet Engineering Task Force (IETF) in the RFC 2748, herein included by reference.

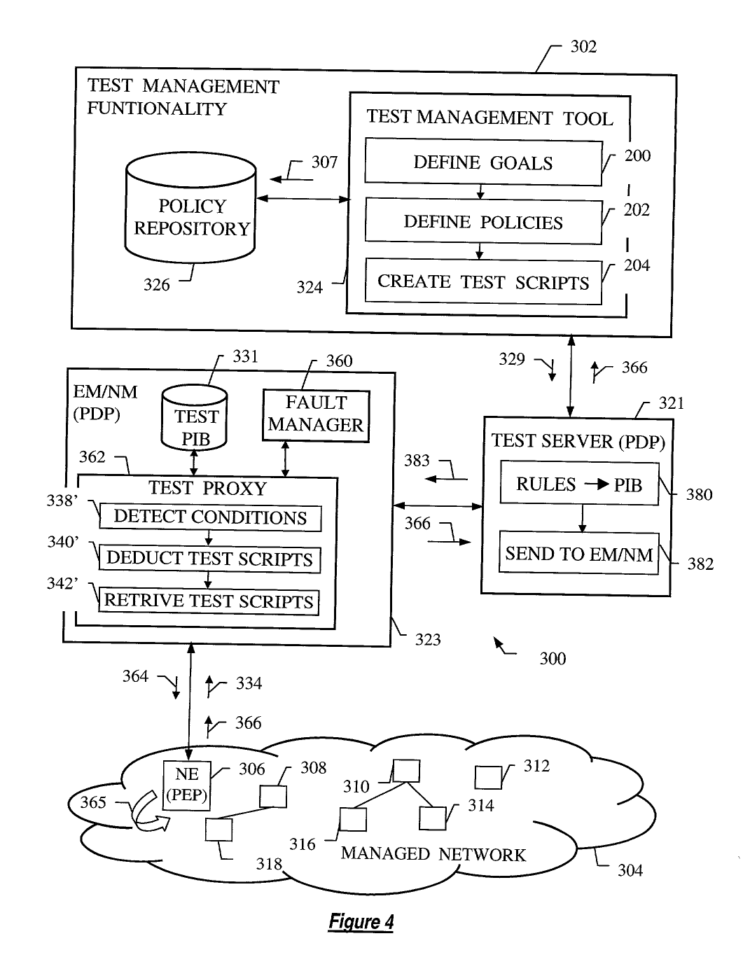

FIG. 4 is an exemplary high-level network diagram of a second variant of the preferred embodiment of the present invention. The same test management system 300 comprises the same test management functionality 302 responsible for the definition of test goals, test policies and test scripts that are to be used for the management of a managed network 304 comprising one or more managed network elements 306-318, as also described with relation to FIG. 3. A test server 321 is used for interfacing the test management functionality 302 with an Element Manager/Network Manager (EM/NM) 323, which comprises element management functions and subnetwork management functions as defined, for example, in the previously described Technical Specification 3GPP TS-32.101.

First, a test management tool 324 may be used in order to define the high-level test goals, action 200, define the high-level test policies in accordance with the high-level test goals, action 202, and create corresponding test scripts based on the previously defined test policies, action 204. The test policies created in action 204 may also be temporarily stored on a policy repository 326 of the test management functionality 302, action 307, pending conversion into test scripts.

Once the test policies and the test scripts are defined and created, they are sent in action 329 to the test server 321, which formats the test policies and the test scripts into a test Policy Information Base (PIB) format appropriate for storing into the EM/NM 323, action 380. To this extent, the test server 321 acts as a PDP. Following action 380, the test server transmits in action 382 the test PIB information 383 to the EM/NM 323 where they may be stored in a test Policies Information Base (PIB) repository 331. The test PIB may comprise test rules having an expression of the form “IF (Condition) THEN (Action)”, wherein the “Action” is linked to an execution of one or more test scripts on one or more network elements, and the associated test scripts.

A test proxy 362 acts as a Policy Decision Point (PDP) on behalf of the EM/NM 323 for enforcing the test policies. For this purpose, the test proxy may continuously monitor for detecting a conditions similar to the one(s) set into the test policies provisioned to the test PIB 331, which would trigger execution of the test scripts. For example, following the provision of the test rules and the test scripts to the test PIB 331, the monitored network element 306 can issue and transmit an alarm 334 to the EM/NM 323, which receives the alarm 334 through the test proxy 362, which detects if the received alarm notifications 334 equals one of the conditions set into the test policies stored in the test PIB 331, action 338′, and if so, deducts the corresponding test scripts to be executed for such a condition, step 340′. Once the required test scripts are identified, the test proxy 362 retrieves the test scripts from the test PIB 331, action 342′, and transmits them to the appropriate network element 306 that acts as a Policy Enforcement Point (PEP), action 364, which executes the test scripts, action 365. Once the tests are completed, the test results are reported back to the test management tool 302, or to any other administrative entity as for example predefined by a network administrator, action 366.

According to the second variant of the preferred embodiment of the present invention herein described in relation to FIG. 4, other events or conditions than the alarm notification 334 may trigger the described execution of the test scripts, as also depicted herein with relation to FIG. 3.

It is to be noted that in the example described in relation to FIG. 4, also called herein the provisioning model where the test decisions are prefigured in the EM/NM, prior to processing events, and the tests are conducted following predictable scenarios based on external events. Test provisioning may be performed in bulk (e.g., end-to-end tests where many network elements are involved) or in portions (e.g., specific tests on one network element).

The protocol used for communications between the test server 321 and the EM/NM 323 is the COPS-PR (Common Open Policy Service extensions for PRovisioning) protocol as defined in the Request for Comments (RFC) RFC-3084, herein included by reference, published by the Internet Engineering Task (IETF). COPS-PR is based on COPS protocol for the support of policy provisioning. Its specification is independent of the type of policy being provisioned. COPS-PR can be used to communicate test decisions to network resources (PEPs). The data model assumed in COPS-PR is based on the concept of Policy Information Bases (PIBs) that defines the policy data.

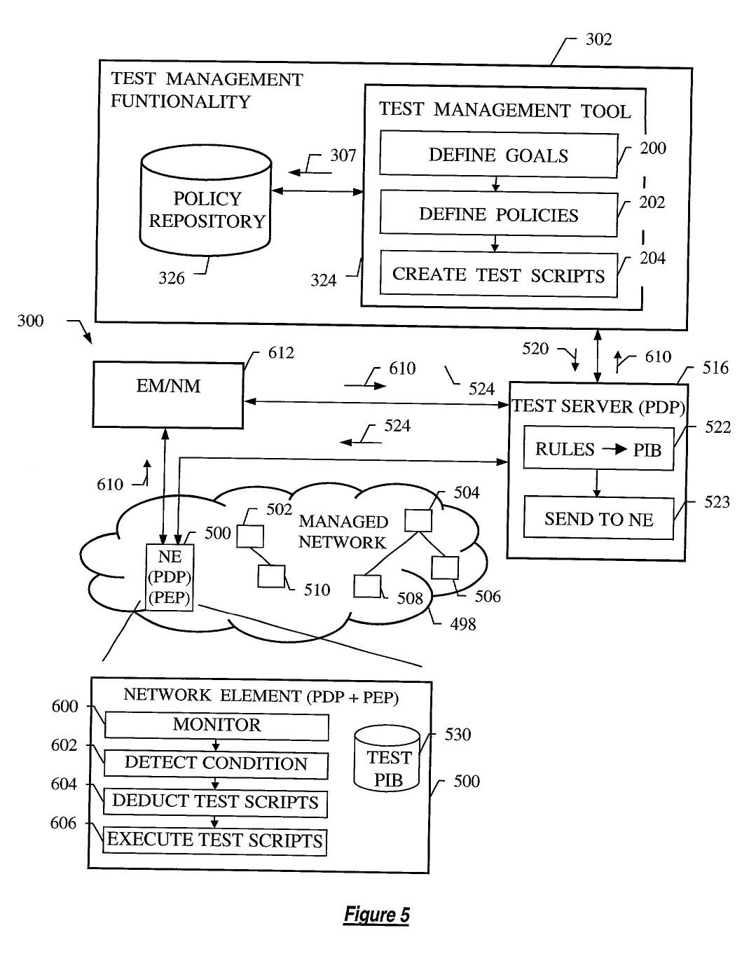

FIG. 5 is an exemplary high-level network diagram of a third variant of the preferred embodiment of the present invention wherein the test PIB information is stored in the monitored network element itself, which according to this variant acts both as a PDP by detecting the particular conditions and by deriving the actions and test scripts to be taken and executed in such a condition, and as a PEP, by executing the test scripts associated to the actions. According to this variant of the invention, the same test management system 300 comprises the same test management functionality 302 responsible for the definition of test goals, test policies and test scripts that are to be used for the management of a managed network 498 comprising one or more managed network elements 500510. A test server 516 is used for interfacing the test management functionality 302 with one or more network elements of the managed network, such as for example with network element 500.

First, a test management tool 324 may be used in order to define the high-level test goals, action 200, define the high-level test policies in accordance with the high-level test goals, action 202, and create corresponding test scripts based on the previously defined test policies, action 204. The test policies created in action 204 may also be temporarily stored on a policy repository 326 of the test management functionality 302, action 307, pending conversion into test scripts. Once the test policies and the test scripts are defined and created, they are sent in action 520 to the test server 516, which formats the test policies and the test script into a test PIB format appropriate for storing into Network Elements (NEs), action 522. To this extent, the test server 516 acts as a PDP. The test server then transmits in action 523 the test PIB information 524 the appropriate network element 500. The test PIB may comprise test rules having an expression of the form “IF (Condition) THEN (Action)”, wherein the “Action” is linked to an execution of one or more test scripts on one or more network elements, and the associated test scripts.

The network element 500 stores the test PIB locally, 530, and may continuously monitor for detecting a condition similar to the one(s) set into the test policies provisioned to the test PIB 530, action 600, which would trigger execution of the test scripts. For example, following the provision of the test rules and the associated test scripts to the test PIB 530, the network element 500 can detect a given condition, such as for example but not limited to a time value, a processing load value or threshold (e.g. for dropped calls), and detect if this condition equals one of the conditions set into the test policies stored in the test PIB 530, action 602. If so, the network element 500 deducts the corresponding test scripts to be executed for such a condition, step 604, by consulting the test PIB 530. Once the required test scripts are identified, the network element 500 retrieves the test scripts from the test PIB 530 and executes the test scripts, action 606. Once the tests are completed, the test results are reported back to the test management tool 302, to an Element Manager/Network Manager (EM/NM) 612, or to any other administrative entity as for example predefined by a network administrator, action 610.

It is to be noted that in the example described in relation to FIG. 5, also called herein an provisioning model for test policies-aware network elements understanding COPS-PR (clients of COPS-PR) the protocol used for communications between the test server 516 and the EM/NM 612 or the network element 500 is the COPS-PR (Common Open Policy Service extensions for PRovisioning) protocol as defined in the Request for Comments (RFC) RFC-3084 published by the Internet Engineering Task (IETF). COPS-PR is based on COPS protocol for the support of policy provisioning. Its specification is independent of the type of policy being provisioned. COPS-PR can be used to communicate test decisions to network resources (PEPs). The data model assumed in COPS-PR is based on the concept of Policy Information Bases (PIBs) that defines the policy data.

Based upon the foregoing, it should now be apparent to those of ordinary skill in the art that the present invention provides an advantageous solution, which offers an easy convenient concept of applying policy-based management techniques to the network testing area. Although the system and method of the present invention have been described with particular reference to certain radio telecommunications messaging standards, it should be realized upon reference hereto that the innovative teachings contained herein are not necessarily limited thereto and may be implemented advantageously with any applicable radio telecommunications standard. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for policy-based test management, the method comprising the steps of:
i) defining at least one high-level test policy for test management, the test policy comprising one or more testing actions to be executed when one or more pre-defined conditions are met;
ii) based on the high-level test policy, creating one or more test scripts associated to the testing actions of the test policy, the test scripts being set to be executed when the one or more pre-defined conditions are met;
iii) detecting when the one or more pre-defined conditions are met; and
iv) executing the one or more test scripts.

2. The method claimed in claim 1, wherein the steps i) and ii) are performed by a test management functionality.

3. The method claimed in claim 1 further comprising, prior to step i), the step of:
defining high-level test goals;
wherein the at least one high-level test policy for test management is defined according to the test goals.

4. The method claimed in claim 1, wherein the at least one high-level test policy is vendor-independent.

5. The method claimed in claim 1, wherein the at least one high-level test policy is technology-independent.

6. The method claimed in claim 1, further comprising between steps iii) and iv) the step of:
v) using the high-level test policy to deduct which test scripts are to be executed based on the detected pre-defined conditions.

7. The method claimed in claim 1, wherein the at least one high-level test policy comprises an expression of the form IF(condition)THEN(action), wherein a condition parameter is related to the one or more pre-defined conditions, and an action parameter is related to the one or more test scripts.

8. The method claimed in claim 6, wherein steps iii) and v) are performed in a test server, and wherein the method further comprises the step of:
transmitting the one or more test scripts to be executed from the test server to a network element acting as a Policy Enforcement Point (PEP), wherein step iv) is performed by the network element.

9. The method claimed in claim 6, wherein steps iii) and v) are performed in an Element Manager/Network Manager (EM/NM) acting as a Policy Decision Point (PDP), and wherein the method further comprises the step of:
transmitting the high-level test policy along with the one or more test scripts associated to the test policy from a test server to the EM/NM, wherein the EM/NM forwards the one or more test scripts to a network element connected to the EM/NM.

10. The method claimed in claim 6, wherein steps iii), iv) and v) are performed in a network element of a managed network, and wherein the method further comprises the step of:
transmitting the high-level test policy along with the one or more test scripts associated to the test policy from a test server to the network element.

11. The method claimed in claim 10, wherein the network element stores the high-level test policy along with the one or more test scripts associated to the test policy in a Policy Information Base (PIB).

12. The method claimed in claim 9, wherein the protocol used for performing the step of transmitting the high-level test policy along with the one or more test scripts associated to the test policy from a test server to the EM/NM is the Common Open Policy Service extensions for PRovisioning (COPS-PR) protocol.

13. A policy-based test management system comprising:
a test management functionality defining at least one high-level test policy for test management comprising one or more testing actions to be executed when one or more pre-defined conditions are met, wherein the test management functionality is used to create one or more test scripts associated to the testing actions and based on the high-level test policy, the test scripts being set to be executed when the one or more pre-defined conditions are met; and
a Policy Decision Point (PDP) connected to the test management functionality and detecting when the one or more pre-defined conditions are met.

14. The policy-based test management system claimed in claim 13, wherein the test management functionality is first used for defining high-level test goals, and the test policy for test management is defined according to the test goals.

15. The policy-based test management system claimed in claim 13, wherein the at least one high-level test policy is vendor-independent.

16. The policy-based test management system claimed in claim 13, wherein the at least one high-level test policy is technology-independent.

17. The policy-based test management system claimed in claim 13, wherein the PDP uses the high-level test policy to deduct which test scripts are to be executed based on the detected pre-defined conditions.

18. The policy-based test management system claimed in claim 13, wherein the at least one high-level test policy comprises an expression of the form IF(condition)THEN(action), wherein a condition parameter is related to the one or more pre-defined conditions, and an action parameter is related to the one or more test scripts.

19. The policy-based test management system claimed in claim 18, wherein:
the PDP is connected to the test management functionality and receives from the test management functionality the test policy along with the associated test scripts, wherein when the one or more pre-defined conditions are met, the PEP deducts from the test policy which test scripts are to be executed and triggers an execution of the test scripts.

20. The policy-based test management system claimed in claim 19, further comprising:
a network element of a managed network connected to the PDP, wherein the PDP transmits to the network element the test scripts to be executed by the network element.

21. The policy-based test management system claimed in claim 19, wherein the PDP is a test server comprising a memory for storing the test policies along with the associated test scripts.

22. The policy-based test management system claimed in claim 19, wherein the PDP is an Element Manager/Network Manager (EM/NM) connected to a network element of a managed network and comprising a Policy Information Base (PIB) for storing the test policies along with the associated test scripts.

23. The policy-based test management system claimed in claim 19, wherein the PDP is a network element of a managed network and comprising a Policy Information Base (PIB) for storing the test policy along with the associated test scripts.

24. A Policy Decision Point (PDP) comprising:
a Policy Information Base (PIB) storing:
i) at least one high-level test policy for test management, the test policy comprising one or more testing actions to be executed when one or more pre-defined conditions are met;
ii) one or more test scripts associated with the testing actions of the test policy, the test scripts being set to be executed when the one or more pre-defined conditions are met;
an engine detecting when the one or more pre-defined conditions are met, and if so, triggering an execution of the test scripts.

25. The PDP claimed in claim 24, wherein the PIB is provisioned with the test policy and the test scripts from a test management functionality.

26. The PDP claimed in claim 24, wherein the PDP is a test server and the engine is a rule-based engine.

27. The PDP claimed in claim 24, wherein PDP is an Element Manager/Network Manager (EM/NM) and the engine is a fault manager.

28. The PDP claimed in claim 24, wherein when the one or more pre-defined conditions are met, the PDP sends the one or more test scripts to a network element a managed network, which in turn executes the one or more test scripts.

29. The PDP claimed in claim 24, wherein when the one or more pre-defined conditions are met, the PDP acts also as a Policy Enforcement Point and executes the one or more test scripts.
